(19) United States
(12) Patent Application Publication
(10) Pub. No.: US 2009/0087646 A1
(43) Pub. Date: Apr. 2, 2009

(54) COATED SUBSTRATE, COMPOSITION FOR TREATING A SUBSTRATE AND PROCESS OF TREATMENT

(75) Inventor: Gino Sirejacob, Evergem (BE)

Correspondence Address: DARBY & DARBY P.C., P.O. BOX 770, Church Street Station, New York, NY, 10008-0770, US

(73) Assignee: CF Supplies International Ltd., Gloucester (GB)

(21) Appl. No.: 11/865,409

(22) Filed: Oct. 1, 2007

(51) Int. Cl. B32B 9/04; B05D 1/02; C09D 1/00

(52) U.S. Cl. 428/336; 106/287.1; 427/421.1

(57) ABSTRACT

A siliceous substrate having at least a portion of a face which is provided with a water-repellent fluoro silane layer substantially equally distributed at a fluoro silane coating rate comprised between 2 mg/m² and 30 mg/m².

### FIELD OF THE INVENTION

The present invention relates to composition and a process for treating substrates containing silicon (Si), especially siliceous containing substrate, for rendering them water, oil, stain and dirt repellent.

### STATE OF THE ART

Fluorochemical treatment of glass has already been proposed for years in order to have stain and water-repellent properties.

The articles “Fluorochemical Glass treatments”, Francen et al, The Glass Industry, 46, p. 594-1965 discloses the still increasingly wider use of fluorochemicals. As stated in said article, usually concentrations of active solids from 0.01 to 0.2 percent are sufficient. The treated glass has some chemical resistance against acid, but is not resistant to sodium hydroxide. The fluorochemical silicon compounds are said to be applied to surfaces from organic solvents or water by brushing, spraying or immersion.

JP-A10147739 discloses composition for foaming antireflection film having a low refractive index. The composition comprises a modified fluoro copolymer obtained by reacting a reactive-group-containing fluoro copolymer with a silane coupling agent.

EP1217119 discloses a water-soluble, water/oil repellent treating composition comprising the reaction product by cohydrolysis and condensation of a fluorinated alkyl-bearing alkoxysilane, an amino-bearing alkoxysilane, and an alkoxysylil-bearing polyorganosiloxane in water.

WO 02/30848 discloses compositions comprising fluorinated polyether silanes for rendering substrates oil and water repellent, an acid, water and an organic solvent. The coating composition applied on the substrate comprises from 0.01 to 5 percent by weight of fluorinated silane.

EP-A-1.171.396 (U.S. Pat. No. 6,379,448) teaches siliceous substrate provided with a fluoro aliphatic silane layer, said layer having excellent mechanical and chemical properties. According to examples, the siliceous substrate is treated with a composition which is prepared before contacting the surface to be treated, by mixing a composition comprising silane and an organic solvent for said silane, and a composition comprising an organic solvent and concentrated hydrochloric acid (HCl). The pot live of the composition when prepared is limited to less than 5 days.

WO 02/30848 teaches a composition for treating a substrate comprising a fluorinated polyether silane, an organic or inorganic acid, water and an organic solvent. Tests have been made by applicant with composition according to said document (composition sold under the trade name ECC-1000). The pot life of the composition is limited whereby the composition has to used in less than 1 day. Furthermore, the layer obtained on a glass substrate with this composition had mechanical properties and chemical resistance properties which were lower than the properties of the layer prepared as taught in EP-A-1.171.396.

WO 2004/026784 relates to compositions for treating substrate and process of treatment

U.S. Pat. No. 6,300,379 teaches a method for improving the stability of an aqueous solution comprising a fluoro organo silane, by including in the aqueous composition 1 to 10% by weight based on the total weight of the aqueous solution a surfactant, and 1 to 9% by weight of a glycol ether co-solvent. The amount of fluoro organo silane present in the aqueous composition is comprised between 0.01 and 3%.

U.S. Pat. No. 5,997,943 discloses a composition for coating a face of a glass with a non-wettable coating layer. The coating composition is prepared by mixing a fluoroalkoxysilane, an aqueous solvent system and a catalyst. The aqueoous solvent is a mix of alcohol and water, while the catalyst is Bronsted acid or base. Water represents from 3 to 20% by volume, based on said alcohol. The coating composition comprises:

from 0.05% to 5% by weight, preferably between 1 and 3% by weight fluoroalkoxysilane; and

from 0.005 to 20% by weight, preferably about 10% by weight catalyst.

In the process of U.S. Pat. No. 5,997,943, it is necessary to apply a primer to the substrate, before applying the coating composition, so as to achieve an angle of 90° or more after 100,000 to 250,000 windshield wiper cycles. The primer consists of a mix of SiX4, with X representing a halide or an alkoxy, an aqueous solvent system and a catalyst.

Without said primer coating, it is not possible to achieve with the coating composition of U.S. Pat. No. 5,997,943 an angle of 85° after 100,000 windshield cycles.

The composition of the invention enables to achieve an angle of more than 85°, especially more than 90° after more 250,000 washability cycles, without the need to provide the silicon containing substrate with any primer coating. The composition of the invention can thus be applied directly on the cleaned surface.

Furthermore, it has been observed that in case the surface to be coated was not correctly cleaned, the coated product had still good properties.

The content of all said above referenced documents is incorporated in the present specification by reference, especially for the disclosure of fluorosilanes and acids.

Applicant has now discovered that by using specific alcohol coating composition containing extremely low amount of fluorosilane, extremely low amount of fluoro solvent, as well extremely low amount of acid system, while being free of water or substantially free of water, it was possible to prepare siliceous substrates having at least a portion of a face which is provided with a water-repellent layer having a thickness of no greater than 1000 Angstroms, said layer being a layer of at least one fluoro silane compound having at least one silicon atom chemically bound to the siliceous substrate and chemically bound to the silicon atom of another fluoro silane compound of the layer, the said layer having such chemical bounds with the siliceous substrate and such chemical bounds between silicon atoms of the layer that it has a chemical resistance of at least 1 minute against the action of an aqueous solution containing 25% by weight of sodium hydroxide and having a temperature of 25° C., said layer being further characterized in that the layer is a fluoro silane layer substantially equally distributed on said portion at a fluoro silane coating rate comprised between 2 mg/m² and 30 mg/m², and in that, after 200,000 washability cycles of a holder with vileda abrasive medium moving in one direction on said fluorosilane layer, said holder being applied on said fluorosilane layer with a load of 454 g, said fluorosilane layer has still a water repellency such that a droplet of demineralized water placed on the layer has a profile seen from 90° with respect to the movement direction of the holder with a contact angle greater than 85°.

Said coated face has still improved mechanical properties and improved chemical resistance.

It seems that due to the extremely low content of fluoro silane of the coating composition of the invention, there is no disturbance of the excellent mechanical properties. In view of said extremely low amount of fluoro silane and fluoro solvent in the coating composition of the invention, any possible ecological risk due to leakage is prevented.

Embodiments of compositions of the invention were still efficient well after their preparation, whereby rendering it possible to use it as ready-to-use compositions.

### BRIEF DESCRIPTION OF THE INVENTION

The invention relates to a siliceous substrate having at least a portion of a face which is provided with a water-repellent layer having a thickness of no greater than 1000 Angstroms, said layer being a layer of at least one fluoro silane compound having at least one silicon atom chemically bound to the siliceous substrate and chemically bound to the silicon atom of another fluoro silane compound of the layer, the said layer having such chemical bounds with the siliceous substrate and such chemical bounds between silicon atoms of the layer that it has a chemical resistance of at least 1 minute against the action of an aqueous solution containing 25% by weight of sodium hydroxide and having a temperature of 25° C., said layer being further characterized in that the layer is a fluoro silane layer substantially equally distributed on said portion at a fluoro silane coating rate comprised between 2 mg/m² and 30 mg/m², advantageously between 2 mg/m² and 20 mg/m², preferably between 2 mg/m² and 10 mg/m², and in that, after 200,000 washability cycles of a holder with vileda abrasive medium moving in one direction on said fluorosilane layer, said holder being applied on said fluorosilane layer with a load of 454 g, said fluorosilane layer has still a water repellency such that a droplet of demineralized water placed on the layer has a profile seen from 90° with respect to the movement direction of the holder with a contact angle greater than 85°.

Preferably, the layer is a fluoro silane layer substantially equally distributed, whereby the fluoro silane layer has a coating rate per cm² varying between a minimum coating rate and a maximum coating rate, whereby an average in number coating rate per cm² can be determined, said fluoro silane layer being further characterized in that the maximum coating rate per cm² of the coated portion is at most 25%, preferably at most 15%, most preferably at most 10% higher than the average in number coating rate per cm².

According to an embodiment, the coating layer is characterized by a first average in number coating rate per cm² for the coated surface, whereby said coated surface is divided in a first portion characterized with a rating rate per cm² lower than the first average in number coating rate per cm² and a second portion characterized with a rating rate per cm² higher than the first average in number coating rate per cm². The first portion is further characterized by a second average in number coating rate per cm², while the second portion is further characterized by a third average in number coating rate per cm², while the difference between the third average in number coating rate per cm² and the second average in number coating rate per cm² is lower than 0.5 times the first average in number coating rate per cm², advantageously lower than 0.3 times the first average in number coating rate per cm², preferably lower than 0.15 times the first average in number coating rate per cm², most preferably lower than 0.10 times the first average in number coating rate per cm².

According to an preferred embodiment, after 400,000 (advantageously after 600,000, preferably after 800,000) washability cycles of a holder with vileda abrasive medium moving in one direction on said fluorosilane layer, said holder being applied on said fluoro silane layer with a load of 454 g, said fluoro silane layer has still a water repellency such that a droplet of demineralized water placed on the layer has a profile seen from 90° with respect to the movement direction of the holder with a contact angle greater than 85°.

Preferably, the fluorosilane layer is such that said layer is resistant for at least 24 hours at 25° C. when contacted with a composition selected from the group consisting of sulfuric acid with a concentration of more than 99%, phosphoric acid with a concentration of more than 99%, hydrochloric acid with a concentration of 27%, methanol, nitric acid (66%), formic acid with a concentration of 25%, and mixtures thereof.

According to a further characteristic of the siliceous substrate of the invention, the fluorosilane layer is characterized by a delta haze of less than 0.3% measured by the method ASTM D 1044-94, using a Taber abraser under the conditions where the abrading wheel was a CS-10F wheel, the load was 500 g and the number of rotations was 3,000.

The invention relates also to a composition for treating a silicon or siliceous containing substrate, at least 99.5% by weight of said composition consisting of:
from 0.0005% by weight to 0.01% by weight, advantageously from 0.0008 to 0.008% by weight of fluoro silane selected from the group consisting of substantially water insoluble fluoro silanes and mixtures thereof;
possibly, but preferably at least 0.01% by weight of a fluoro solvent system, said amount of fluoro solvent system being at least sufficient for solubilizing completely said fluoro silane selected from the group consisting of substantially water insoluble fluoro silanes and mixtures thereof,
at least 50% by weight of an alcohol system selected from the group consisting of C1 to C4 alcohols, C1 to C4 dialcohols and mixtures thereof,
less than 0.1% by weight acid system
   whereby the acid system is adapted for ensuring a pH of less than 2, preferably less than 1, such as comprised between 0.2 and 1, for the ready-to-use composition, and whereby the water content of said ready-to-use composition is less than 0.5% by weight. The pH of the composition is measured at 25° C. by using a LiCl electrode with an open sleeve.

The composition is sufficient stable, so that large quantity can be prepared for example for a day consumption in a factory.

The invention relates thus to a stable composition suitable for improving the properties of the fluoro silane layer, especially the mechanical properties thereof, in particular to improve the abrasion resistance.

Advantageously, the composition comprises less than 2% by weight fluoro solvent, preferably from 0.02% by weight to 1% by weight fluoro solvent, most preferably from 0.02% by weight to 0.1% by weight. Examples of fluoro solvent are fluorinated solvents, such as fluorinated hydrocarbons, hydrofluoroethers, mixtures thereof. Typical examples are perfluorohexane, perflorooctane, pentafluorobutane, CF₃CFHFHCF₂CF₃, methylperfluoroethers, ethyl perfluorobutyl ether, trifluoromethyl-3-ethoxydodecafluorhexane, ethyl nonafluoro isobutylether, methyl nonafluoro butyl ether, and mixtures thereof. Preferred fluoro solvents are trifluoromethyl-3-ethoxydodecafluorhexane, ethyl nonafluoro isobutylether, ethyl nonafluoro butylether, methyl nonafluoro butyl ether, methyl nonafluoro isobutyl ether and mixtures thereof.

The composition of the invention can comprises other solvent than the fluoro solvent system and the alcohol system. Examples of said other solvents are ketones, acetone, methyl ethyl ketone, esters, ethers, chlorinated solvents, etc. However, preferably, the composition of the invention is preferably free or substantially free of said other solvents.

The composition of the invention is advantageously free of film forming organic polymer, organic polymer and silane without fluoro atoms. The composition of the invention is advantageously also free of organopolysiloxane. According to a detail, the composition of the invention is free or substantially free of water soluble fluoro silane. The composition of the invention comprises thus preferably as material suitable for making a coating or layer on the substrate, substantially only water insoluble fluoro silane.

According to an advantageous embodiment, the composition comprises less than 0.05% by weight acid system, especially from 0.01% by weight to 0.03% by weight acid system.

The composition of the invention comprises for example one or more carboxylic acids, such as formic acid, citric acid, acetic acid, phthalic acid, tartaric acid, or fluorinated organic acids, such as those disclosed in WO 02/30848, one or more inorganic acids, such as sulfuric acid, phosphoric acid, hydrochloric acid (HCl), hydrofluoric acid (HF), nitric acid, and mixtures thereof. The used acid(s) is selected so as to not damage or attack the face to be coated.

Preferably, the acid system is selected from the group consisting of organic acids, inorganic acids and mixtures thereof.

Most preferably, the acid system is selected from the group consisting of formic acid, citric acid, acetic acid, tartaric acid, hydrochloric acid, phosphoric acid, sulfuric acid, nitric acid and mixtures thereof.

Especially, the acid system consists of a mixture of at least one inorganic acid and at least one organic acid.

According to a further advantageous embodiment, the composition of the invention further comprises at least one ammonium and/or phosphonium compound selected from the group consisting of compounds with at least one ammonium group, compounds with at least one phosphonium group, compounds with at least one ammonium group and with at least one phosphonium group, and mixtures thereof, the weight ratio ammonium and/or phosphonium compound/fluoro silane selected from the group consisting of substantially water insoluble fluoro silanes and mixtures thereof being comprised between 0.005 and 1, preferably between 0.005 and 0.1. Possible ratio's are 0.01, 0.02, 0.05, 0.08 and 0.1.

Advantageously, the ammonium and/or phosphonium compound is present in the composition at least partly in the form of a salt thereof. For example, the ammonium and/or phosphonium compound present in the composition is present in the form of its chloride salt, its formate salt, its acetate salt, etc. Preferably, the ammonium and/or phosphonium salt is selected so as to be solubilized in the organic solvent used for the fluoro silane.

The ammonium and/or phosphonium compound is advantageously a compound of general formula

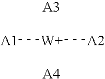

in which A1, A2, A3, A4 comprise an hydrocarbon group with 1 to 6 carbon atoms, preferably an alkyl group with 1 to 6 carbon atoms.

A1, A2, A3, A4 represent preferably each an alkyl group (linear or branched) with 1 to 6 carbon atoms, advantageously with less than 3 carbon atoms, such as with one or two carbon atoms. A1, A2, A3 and A4 represent advantageously a same alkyl group, such as the methyl group.

Specific examples of suitable compounds are tetramethyl ammonium chloride, tetramethyl ammonium bromide, teramethyl ammonium formate, tetramethyl ammonium hydrate, teramethyl ammonium acetate, tetramethyl ammonium sulfate, tetramethyl phosphonium chloride, tetramethyl phosphonium formate, tetra methyl phosphonium citrate, etc. The production and preparation of ammonium and/or phosphonium compounds can be easily found in the literature. Reference can done to U.S. Pat. No. 4,275,235, U.S. Pat. No. 4,110,358, WO 91 05003, WO 91 04668, and the prior art cited in said documents.

The composition of the invention is most preferably substantially water free. The total water content of the composition is for example lower than 0.5% by weight, preferably lower than 0.3%, for example comprised between 0.05 and 0.25%.

The composition of the invention can comprise some amino silane, such as amino alkyl silane or amino propyl alkoxy silane, in particular some amino silane used for the preparation of the fluoro silane or the fluorinated polyether silane. The amino silane present in the composition is for example greater than 0.5% the weight of the fluoro silane present in the composition. The weight ratio amino silane/fluoro silane is advantageously greater than 0.01, preferably greater than 0.02, such as 0.05, 0.1, 0.2 or even more (0.3, 0.5, etc.). Most preferably the weight ratio amino silane/water insoluble fluorosilane is comprised between 0.01 and 0.2. The reaction of formation of the fluoro silane is for example controlled so as to obtain an end fluoro silane containing the required amount of amino silane. Amino silane can also be added as such at the end of the reaction so as to control the amount of amino silane present.

According to a detail, the composition comprises more than 95% by weight, preferably more than 99% by weight of the alcohol system selected from the group consisting of C1 to C4 alcohols, C1 to C4 dialcohols and mixtures thereof. Preferably the composition has an alcohol content of 99% by weight to 99.7% by weight

According to an specific embodiment, less than 0.5% by weight, preferably from 0.1 to 0.3% by weight of the composition consists of:
fluoro silane selected from the group consisting of substantially water insoluble fluoro silanes and mixtures thereof;
fluoro solvent system, said amount of fluoro solvent system being at least sufficient for solubilizing all said fluoro silane selected from the group consisting of substantially water insoluble fluoro silanes and mixtures thereof, and
less than 0.1% by weight acid system

Most preferably, the composition comprises as fluorosilane a fluoro silane selected from the group consisting of fluorinated polyether silanes (such as disclosed in WO 02/30848) of the formula:

R_{f}¹-[-Q-SiY₃₋ₓR¹ₓ]_{y}

wherein R_{f}¹ represent a monovalent or divalent polyfluoropolyether group, Q represents an organic divalent linking group, R¹ represents a C1-C4 alkyl group, Y represents a hydrolysable group, x is 0 or 1 and y is 1 or 2; and mixtures thereof.

Advantageously, the composition is free of water soluble fluoro silane.

The fluorosilane can also be a reaction product of a fluorosilane ether/polythers with amino silanes or chlorosilane, provided that said reaction product is at least a substantially water insoluble fluoro silanes, functionalized fluoro silanes. The fluoro silanes can for example have one or more amino group and/or one or more chlorine atoms. Other function groups are also possible.

According to a specific embodiment, the fluoro silane comprises at least an atom selected from the group consisting of N, P and Cl.

Preferably, the composition comprises ammonium and/or phosphonium compound(s) soluble in the organic solvent, especially in alcohols.

The alcohol system of the invention is advantageously a system containing one or more alcohols selected from the group consisting of C1-C6 alkanol, and aliphatic alcohols of the empirical formula:

[(R₃)ᵢR₄](C1-C6)OH

wherein R₃ and R₄ are each C1-C4 alkoxy, and i is the integer 0 or 1, and mixtures thereof. Preferred examples of alcohols are methanol, ethanol, 2-ethoxyethanol, 2-(2-methoxyethoxy)ethanol, 2-methoxy ethanol, 2-(2-ethoxymethoxy)ethanol, 1-propanol, 2-propanol, 1-methoxy-2-propanol, and mixtures thereof (methanol, ethanol, methoxy-ethanol, propanol and mixtures thereof being the most preferred).

The invention relates also to a composition (free of fluoro solvent) for treating a silicon or siliceous containing substrate, at least 99.5% by weight of said composition consisting of:
from 0.0005% by weight to 0.01% by weight of fluoro silane selected from the group consisting of substantially water insoluble fluoro silanes and mixtures thereof;
at least 99.39% by weight of an alcohol system selected from the group consisting of C1 to C4 alcohols, C1 to C4 dialcohols and mixtures thereof,
less than 0.1% by weight acid system
   whereby the acid system is adapted for ensuring a pH of less than 2 for the ready-to-use composition, and whereby the water content of said ready-to-use composition is less than 0.5% by weight.

Said composition has one or more of the advantageous characteristics of the composition of the invention comprising a fluoro solvent system.

The invention further relates to a process for coating a face of a silicon or siliceous containing substrate with a silicon containing layer, in which the face is treated with a composition for treating a siliceous containing substrate, in which at least 99.5% by weight of said composition consisting of:
from 0.0005% by weight to 0.01% by weight, preferably from 0.0008 and 0.008% by weight of fluoro silane selected from the group consisting of substantially water insoluble fluoro silanes and mixtures thereof;
possibly, but preferably at least 0.01% by weight, advantageously less than 2% by weight, preferably from 0.02% by weight to 1% by weight fluoro solvent system, said amount of fluoro solvent system being at least sufficient for solubilizing completely said fluoro silane selected from the group consisting of substantially water insoluble fluoro silanes and mixtures thereof,
at least 50% by weight of an alcohol system selected from the group consisting of C1 to C4 alcohols, C1 to C4 dialcohols and mixtures thereof,
less than 0.1% by weight acid system
   whereby the acid system is adapted for ensuring a pH of less than 2 for the ready-to-use composition, and whereby the water content of said ready-to-use composition is less than 0.5% by weight.

The composition used in the process of the invention has advantageously one or more characteristics of the composition disclosed in the composition of the invention.

The composition can be applied on various ways on the substrate, such as by contacting the substrate with the liquid composition, by dipping, brushing, spraying, wiping, atomising, flowing, falling, nebulisation, chemical vapor deposition, etc.

Advantageously, prior to be contacted with the solution, the said part of the face is washed, for example degreased, while after to be contacted with the solution, the said part of the face is rinsed, for example with a solvent, a polar solvent, especially with the solvent used in the fluoro silane composition. Prior contacting the substrate with the composition of the invention, it is advantageous to treat the surface with a biocide and/or with an ammonium and/or phosphonium compound.

When pretreating the substrate, the face of the substrate to be treated is advantageously dried or the possible liquid water present on the face is removed by mechanical action, by adsorption or by physical actions.

Prior a cleaning/washing step or a degreasing step or a treatment step with a ammonium/phosphonium composition or a coating step with a composition of the invention, the face of the substrate to be coated is advantageously mechanically treated, for example polished with a polishing composition, such as a polishing composition comprising cerium oxide powders. The face of the substrate, instead being mechanically treated, can chemically be treated with one or more acids suitable for etching. The face of the substrate can also be treated by blasting particles on the face to be coated, for example by sand blasting.

Even if a primer coating is not necessary with the composition of the invention, the face to be coated can be provided with a Si containing primer layer, such as a Si primer layer as disclosed in U.S. Pat. No. 5,997,943.

According to an embodiment of the process, the drying or curing of the composition is carried out at room temperature. A substantially complete drying or curing of the fluoro silane layer can be reached in less than about 24 hours.

Preferably, possibly after drying or removal of solvent or water, the said face is subjected to a heat treatment at a temperature from 30° C. up to about 250° C., for example from 40° C. to about 200° C., in an oxidative atmosphere or up to about 350° C. in a non-oxidative atmosphere.

During the contact of the substrate with the composition as well as during the curing step, the atmosphere is controlled. For example, the humidity level of the gas present in the room where the substrate is contacted with the composition. The temperature is also kept advantageously as low as possible, for example at a temperature comprised between 5 and 65° C., such as a temperature comprised between 20 and 50° C. The treatment can be made under pressure.

The siliceous substrate is advantageously selected from the group consisting of glass, glass containing substrates, ceramics and silicate surfaces. Other possible substrates are listed in WO 02/30848, the content of which is incorporated by reference.

Advantageously, the amount of ammonium and/or phosphonium compound present in the composition is lower than the amount of substantially water insoluble fluorosilane, preferably lower than 0.5 time the amount of substantially water insoluble fluoro silane, most preferably lower than 0.1 time the amount of substantially water insoluble fluoro silane. For example, the weight ratio (ammonium compound or phosphonium compound or ammonium+phosphonium compound or mixture thereof)/substantially water insoluble fluoro silane is 0.05; 0.03; 0.02; 0.01 or even less.

Advantageously, prior to be contacted with the solution, the said part of the face is washed, for example degreased, while after to be contacted with the solution, the said part of the face is rinsed, for example with a solvent for the fluoro silane compound.

The drying and curing of the composition applied onto the substrate is preferably carried out after removal of the excess of composition present on the substrate, for example by using a wool cloth or fabric, a cotton cloth or fabric, etc. The said cloth or fabric can also be used for ensuring a good application of the composition on the whole surface, especially along the edge of the siliceous substrate. The removal of excess of composition present on the surface can also be removed by applying on said surface water or solvent, such as a large amount of water. Preferably an alcohol is used for removing said excess of composition present on the face to be coated, whereby an alcohol composition is obtained, said alcohol composition being suitable for the preparation of a new composition of the invention.

The application, as well as the drying and curing of the composition can be carried at outside temperature in an uncleaned (non-cleaned) atmosphere. For example the application, as well as the drying and curing can be carried out at temperature from −50° C. up to the degradation of the fluoro silane layer. It is obvious that the application and the drying and curing of the composition can be carried out in a cleaned atmosphere. It is for example possible to apply the composition on the glass sheet or glass pieces just after its manufacture, for example after a cooling step.

When the drying is carried out at a lower temperature, the time required for obtaining a sufficient drying and curing will be longer.

The application is for example carried out at a temperature comprised between 0 and 50° C. The drying and curing can also be carried out in this range of temperature.

According to an embodiment of the process, the drying or curing of the composition is carried out at room temperature, without requiring a cleaned atmosphere. A substantially complete drying or curing of the fluoro silane layer can be reached after about 24 hours.

Preferably, possibly after drying or removal of solvent, the said face is subjected to a heat treatment at a temperature from 30° C. up to about 250° C., for example from 40° C. to about 200° C., in an oxidative atmosphere or up to about 350° C. in a non-oxidative atmosphere.

The said composition is advantageously at least substantially free of organic polymer, of film forming organic polymer, of silane without fluorine atoms, so that the layer is substantially only formed by fluoro silane.

The drying step can be a mechanical removal of excess of composition and polar solvent present on the siliceous substrate or of an excess of water or solvent (preferably polar solvent) used for rinsing the substrate after being contacted with the composition. However, advantageously, prior to be contacted with the solution, the said part of the face is washed (for example degreased), while after to be contacted with the solution, the said part of the face is rinsed. The drying step is preferably carried out at least partly at a temperature sufficient for making covalent bonds (oxygen bonds) between the layer and the substrate. Said drying can be carried out at a temperature comprised between −20° C. and 250° C. in an oxidative atmosphere and between −20° C. and about 350° C. in a non-oxidative atmosphere. The drying can be done possibly under vacuum.

Before contacting a face of the siliceous substrate with the silane composition, the said face can be partly or completely treated so as to ensure that the surface is dust free, fat free and free of silicone or other compounds grafted to the face of the siliceous substrate on which a fluoro silane layer according to the invention has to be applied, and/or so as to ensure a kind of abrasion of the said face (for example by projection of small high resistant particles or particle dusts, for example of SiC particles or dust).

Such washing or cleaning pretreatment includes ultrasonic cleaning; washing with an aqueous mixture of organic solvent, e.g., a 50:50 mixture of isopropanol:water or ethanol:water; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant, washing the glass with an aqueous solution that may contain a low foaming, easily rinsed detergent, followed by rinsing and drying with a lint-free cloth; and ultrasonic bath treatment in heated (about 50.degree. C.) wash (preferably deionized) water, followed by rinsing and drying. A pre-cleaning with an alcohol-based cleaner or organic solvent prior to washing may be required to remove adhesives from labels or tapes. Cleaning may also advantageously comprise a polishing step. After drying, the base or glass sheet may be washed with a polar solvent, specifically a chlorinated solvent and/or a fluorinated solvent. Alternatively, and preferably, the base is exposed to an oxidizing atmosphere to improve the reactivation of the glass; for example, to a combination of ozone and UV radiation. It is clear that the siliceous substrate or glass can be submitted to various washing and cleaning pre-treatments.

For removing silicone oil or compounds possibly grafted to the siliceous substrate, the substrate can be treated with ammonium fluoride solution, potassium hydroxide (at boiling temperature), HF, Silstrip Liquid® of PENN-WHITE (UK), etc.

In the process according to the invention, the composition when being applied on the substrate still contains silane oligomer (product of the condensation of silane monomer or silanol) with up to 6 Si atoms, preferably with up to 3 Si atoms.

In the process of the invention, the siliceous or silicon containing substrate is contacted advantageously with the composition of the invention at a rate of less than 800 ml per m², preferably less than 400 ml per m², most preferably less than 200 ml per m², such as less than 100 ml/m², especially from 1 to 50 ml/m², but advantageously from 10 ml/m² to 100 ml/m², especially from 10 ml/m² to 50 ml/m², more especially from 10 ml/m² to 20 ml/m². As the rate of coating composition per m² can be very low, the composition of the invention can be applied by pulverization, spraying, nebulisation, chemical vapor deposition or even by a wiping technique.

The siliceous or silicon containing substrate is advantageously contacted with the composition at a rate of less than 800 ml per m² (preferably less than 400 ml per m², most preferably less than 200 ml per m², such as from 10 ml/m² to 100 ml/m², especially from 10 ml/m² to 50 ml/m², more especially from 10 ml/m² to 20 ml/m²) for less than 10 minutes at a temperature comprised between 0° C. and 60° C.

The contact time of the composition with the substrate can be extremely short, for example less than 10 minutes, preferably less than 5 minutes, especially less than 2 minutes.

Advantageously, the coating composition is pulverized, sprayed, atomized or nebulized on the siliceous or silicon containing substrate with a gas. Said gas is advantageously propane, isobutane, butane, dimethylether and mixtures thereof.

The invention relates also to a process for coating a face of a silicon or siliceous containing substrate with a silicon containing layer, in which the face is treated with a composition for treating a siliceous containing substrate which is free of fluoro solvent, in which at least 99.5% by weight of said composition consisting of:
from 0.0005% by weight to 0.01% by weight (advantageously from 0.0008 and 0.008% by weight) of fluoro silane selected from the group consisting of substantially water insoluble fluoro silanes and mixtures thereof;
at least 99.39% by weight of an alcohol system selected from the group consisting of C1 to C4 alcohols, C1 to C4 dialcohols and mixtures thereof,
less than 0.1% by weight acid system
   whereby the acid system is adapted for ensuring a pH of less than 2 for the ready-to-use composition, and whereby the water content of said composition is less than 0.5% by weight. Said process has advantageously one or more characteristics disclosed here above for the process using fluoro silane.

The invention further relates to a kit for the preparation of a ready-to-use composition of the invention, said ready-to-use composition being such that at least 99.5% by weight of said composition consists of:
from 0.0005% by weight to 0.01% by weight of fluoro silane selected from the group consisting of substantially water insoluble fluoro silanes and mixtures thereof;
at least 0.01% by weight of fluoro solvent system, said amount of fluoro solvent system being at least sufficient for solubilizing completely said flouorosilane selected from the group consisting of substantially water insoluble fluoro silanes and mixtures thereof,
at least 50% by weight of alcohol system selected from the group consisting of C1 to C4 alcohols, C1 to C4 dialcohols and mixtures thereof,
less than 0.1% by weight acid system
   whereby the acid system is adapted for ensuring a pH of less than 2 for the ready-to-use composition, and whereby the water content of said ready-to-use composition is less than 0.5% by weight.

The kit comprises at least:

According to a first embodiment

(a) a first container comprising a first composition, at least 99.5% by weight of said first composition consisting of:
fluoro silane selected from the group consisting of substantially water insoluble fluoro silanes and mixtures thereof;
fluoro solvent system in an amount at least sufficient for solubilizing at room temperature all said fluoro silane selected from the group consisting of substantially water insoluble fluoro silanes and mixtures thereof,
alcohol system selected from the group consisting of C1 to C4 alcohols, C1 to C4 dialcohols and mixtures thereof,
   said first composition comprising less than 1% by weight fluoro silane, more than 95% by weight alcohol system, and less than 0.5% by weight water, said first composition being free of acid system, and
   (b) a second container comprising a second composition, at least 99.5% by weight of said second composition consisting of:
at least 95% by weight of alcohol system selected from the group consisting of C1 to C4 alcohols, C1 to C4 dialcohols and mixtures thereof,
less than 4.5% by weight acid system
   said second composition being free of fluoro silane and comprising less than 0.5% by weight water,
   and according to another embodiment,
   (a) a first container comprising a first composition, at least 99.5% by weight of said first composition consisting of:
fluoro silane selected from the group consisting of substantially water insoluble fluoro silanes and mixtures thereof;
fluoro solvent system in an amount at least sufficient for solubilizing at room temperature all said fluoro silane selected from the group consisting of substantially water insoluble fluoro silanes and mixtures thereof,
   said first composition comprising less than 40% by weight fluoro silane, more than 59.5% by weight alcohol system, and less than 0.5% by weight water, said first composition being free of acid system, and
   (b) a second container comprising a second composition, at least 99.5% by weight of said second composition consisting of:
at least 95% by weight of alcohol system selected from the group consisting of C1 to C4 alcohols, C1 to C4 dialcohols and mixtures thereof,
less than 4.5% by weight acid system
   said second composition being free of fluoro silane and comprising less than 0.5% by weight water.

Advantageously, the first container comprises a volume of the first composition, while the second container comprises a volume of the second composition, whereby the first composition and the second composition are adapted so that the mixing of the volume of the first composition and the volume of the second composition, forms a liquid mixture such that at least 99.5% by weight of said liquid mixture consists of:
from 0.0005% by weight to 0.01% by weight of fluoro silane selected from the group consisting of substantially water insoluble fluoro silanes and mixtures thereof;
at least 0.01% by weight of fluoro solvent, said amount of fluoro solvent being at least sufficient for solubilizing all said flouorosilane selected from the group consisting of substantially water insoluble fluoro silanes and mixtures thereof,
at least 50% by weight of alcohol system selected from the group consisting of C1 to C4 alcohols, C1 to C4 dialcohols and mixtures thereof,
less than 0.1% by weight acid system
   whereby the acid system of said liquid mixture is adapted for ensuring a pH of less than 2, and whereby the water content of said liquid mixture is less than 0.5% by weight.

According to a specific embodiment, the kit further comprises:

(c) a third container comprising a third composition, at least 99.5% by weight of said third composition consisting of alcohol system selected from the group consisting of C1 to C4 alcohols, C1 to C4 dialcohols and mixtures thereof, whereby said third composition being free of fluoro silane and of acid system.

Preferably, the second composition and/or the third composition are free of fluoro solvent.

The siliceous containing substrate is preferably contacted with the solution at a temperature comprised between 0 and 50° C., for example at room temperature or at a temperature lower than 15° C. The application can be carried out in a non cleaned atmosphere. Low temperatures are preferred so as to avoid as much as possible cross-linking of silane and so as to reduce as much as possible the formation of larger oligomer in the composition before being applied on the substrate.

In an advantageous embodiment of the process according to the invention, after applying the composition onto a face of the substrate, the said face is submitted to a rubbing with a cloth or fabric, especially with a wool fabric or cloth. It seems that the rubbing of material, such as a wool fabric, suitable for creating static force against the surface of the substrate on which the composition has been applied is advantageous for ensuring an excellent application of the composition onto the said face. The said rubbing can be done manually or mechanically, for example by means of a rotating head provided with a wool fabric.

In an advantageous embodiment of the process, after contacting the said face of the substrate with the composition, the said face is rinsed (for example, by means of water, a polar solvent or a mixture thereof) so as to remove the excess of fluoro silane present on the substrate and dried at least partly at a temperature lower than 50° C. (for example by means of dry air, air having a relative humidity lower than 60%). Preferably, the drying is carried out in a first step by a mechanical treatment so as to remove at most completely the solvent present on the surface of the substrate.

After a possible drying step of the substrate and/or the mechanical removal of the excess of fluoro silane, it is advantageous to submit the face of the substrate to a heat treatment at a temperature above 30° C., for example from 40° C. up to 200° C., so as to increase the formation of bonds (oxygen bonds) of fluoro silane oligomers with the substrate and therebetween. The said heat treatment can be carried out at higher temperature lower than the degradation temperature of the fluoro silane, for example up to 350° C., in a non oxidative atmosphere. In oxidative atmosphere, it is advisable to use about 250° C. as maximum temperature. Such a heat treatment is also a drying step.

The drying step can also be carried out at low temperature, for example at room temperature in a cleaned atmosphere as well as in a non-cleaned atmosphere. In this case, the time necessary for obtaining a sufficient condensation of fluoro silane with the substrate is longer (for example 15 to 36 hours, especially about 24 hours).

The process of the invention can be carried out on various siliceous containing substrates, such as glass, ceramics, ceramics tiles and silicate surfaces.

Examples of possible substrate are:

a glass sheet, glass sheet for a window, a car window, boat window, window of airplanes, control windows of reactors, etc.; the cleaning of the glass sheet being very easy, there are less impacts of insects, less dirt, . . . , especially a wiper blade provided with a fluoro layer or a fluorinated layer (for example a wiper blade according to WO 9812085) is used with such windows;

glasses, wineglasses, etc.; whereby a correct washing of the glasses can be carried by using only water;

contact lenses, objectives (for example of microscopes, cameras, etc.);

etched glass, sand blasted glass, polished glass,

a solgel containing SiO₂ particles;

SiO₂ particles used in toner, as additives in organic or inorganic composition, in cement, in paints, in fluidised bed, in filters (as filter cake for example), in screenings, in classifications processes, in heavy media separation processes, etc.;

Lamps, neon lamps, etc.;

Transparent protection sheet of solar electrical cells;

Bottles, vials, tubes, glass syringes, etc., said bottles, vials, tubes, syringes having at least the inner face provided with a fluoro layer and preferably also the outer face provided with a fluoro layer, so that the washing and/or the sterilisation and/or removal of labels, glued labels is easier, the said bottles, vials and tubes being advantageously closed by means of a stopper (for example a rubber stopper) provided with a fluoro layer or a fluorinated layer so as to have a good sealing contact between the stopper and the neck of the bottles, vials or tubes, while the said syringes have advantageously a plunger provided with a fluoro layer or a fluorinated layer so as to have a good sealing and a low friction when moving the plunger;

Glass fibres, such as optical fibres, glass wool for isolation purposes, for filtering purposes, etc;

High voltage isolators;

Kiezelghur particles for example for filtering purposes;

Analysis tube, control tube, level control system;

Reactor, chemical reactor, condensers, falling film exchangers, reactors, absorbers, etc.;

Sanitary installations;

Enamel or porcelain surfaces, such as wash basin or vat, etc.;

Siliceous substrate with an anti adhesion surface for the manufacture of micro lenses, etc.;

Siliceous substrates as casting moulds;

Siliceous packing elements for towers, such as absorption tower;

Earthenware;

Glass films;

Wood,

Silicon containing steel;

Composite materials;

paper containing SiO₂;

etc.

### DESCRIPTION OF SPECIFIC AND PREFERRED EMBODIMENTS

### Example 1

A first composition has been prepared by adding absolute ethanol to a solution of silane ether in a fluoro solvent (perfluorohexane). The weight ratio silane ether/perfluoro hexane was about 0.25. The ethanol composition is a composition comprising 80% ethanol, 16% by weight perfluorohexane and 4% by weight fluoro silane of the following formula CF₃—(CF₂)₇—(CH₂)₂Si(OCH₃)₃. Tetra methyl ammonium hydroxide (TMAH) was added to the composition, so that the weight ratio TMA/silane is about 0.1

A second composition was prepared by mixing ethanol with chlorhydric acid. Said second composition was substantially water free. Chlorhydric acid was then added so that the pH of the solution was about 1.

The pH was measured by using a Multi-meters pocket “Multiline P4” of WTM sold by VEL (Leuven, BELGIUM) provided with a LiCl electrode (open sleeve electrode, pH Flushtrode with LiCl) of HAMILTON (USA) sold by VEL. Such an electrode is a known electrode for measuring a pH in a polar medium, as well as in a non polar solvent. Even if the pH is measured preferably by using this electrode, other electrodes suitable for measuring pH in polar solvent can be used. The pH was measured at 25° C., even if the Multi-meters apparatus was provided with a system for compensating the variation of the pH in function of the temperature. The apparatus was calibrated by using buffers having respectively a pH of 1.00, 2.00, 3.00, 4.01, 6.99 and 8.98.

The first composition was mixed with a large volume of the second composition so as to form a ready to use composition consisting of:

fluoro silane 0.005% by weight
perfluorohexane 0.02% by weight
TMAH 0.0005% by weight
chlorhydric acid 0.015% by weight
ethanol more than 99.5%

water less than 0.5% (water due to the presence of some water the absolute ethanol).

The pH of said composition was about 1.

The composition was then applied on a glass sheet by dipping the glass sheet in a bath containing the composition. Before applying the composition or fluorosilane solution, the glass sheet was cleaned and degreased by means of organic polar solvents.

After dipping, the excess of solution on the glass sheet was removed by rubbing a wool fabric against the glass sheet. Thereafter, the glass sheet was washed with ethanol.

The so treated glass sheet was then heated at 130° C. during 30 minutes for drying and curing the layer with the substrate (formation of covalent oxygen bonds between the siliceous substrate and the silane layer).

The so obtained layer was a mono layer, having a thickness of lower than 1 μm (thickness corresponding substantially to the length of CF₃—(CF₂)₇—(CH₂)₂ Si).

Tests have been made on the treated glass in order to determine its properties. The results of these tests are the followings

### Resistance Tests

For these tests, two drops of a fluid have been applied for at least 1 minute on the coated glass. A first drop has been removed after a rubbing with a paper cloth and thereafter wiped with cotton, while a second drop was removed without rubbing with a paper cloth and thereafter wiped with cotton. The resistance of the coating to the fluid was determined by checking for tackiness, by examining the crazing, by examining the loss of transparency and hydrophobicity.

The results of these examinations are that the coating has a resistance (minimum resistance, resistance for a minimum period of time) to various chemicals, namely:

Resistance to boiling water (for 1 hour)
Resistance to non abrasive soap solution (2% soap content) (for 24 hours)
Resistance to non abrasive concentrated soap solution (100% soap) (for 24 hours)
Resistance to alcohol (absolute) (for 24 hours)
Resistance to isopropanol (for 24 hours)
Resistance to isoparaffinic hydrocarbon (isopar c) (for 24 hours)
Resistance to acetone (for 24 hours)
Resistance to diacetonalcohol (for 24 hours)
Resistance to methyl ethyl ketone (MEK) (for 24 hours)
Resistance to sec. Butanol (for 24 hours)
Resistance to concentrated HCl (37%) (for 24 hours)
Resistance to sulphuric acid (99%) (for 24 hours)
Resistance to diluted NaOH (resistance of at least 1 minute after applying at 25° C. an aqueous solution containing 5% NaOH)
Resistance of at least 1 minute to an aqueous solution containing 25% NaOH
Resistance of at least 1 minute to an aqueous solution containing 25% KOH
Resistance to nitric acid (68%) (for 24 hours)
Resistance to formic acid (25%) (for 24 hours)
Resistance to citric acid (10%) (for 24 hours)
Resistance to acetic acid (20%) (for 24 hours)
Resistance to gasoline (for 24 hours)
Resistance to diesel (for 24 hours)
Resistance to guano (for 24 hours)

Furthermore, the layer had a resistance of at least 24 hours against the action of concentrated phosphoric acid (99%) at 25° C.

With respect to commercially used water repellent composition, the composition of the invention had resistance which could not be achieved with the commercial compositions, namely resistance to diacetonal+resistance to citric acid+resistance to sulfuric acid+resistance to formic acid+resistance to ethanol (pure)+resistance to brake fluid+resistance to diesel fuel, etc.

### Water-Repellent Tests

The layer was still water-repellent after 5000 hours. For said test water is running continuously on the coating from a high of 50 cm, the glass plate being positioned at an angle of 45° with respect to the horizontal.)

The layer has the following characteristics: abrasion resistance, hydrophobicity, oleophobicity, low friction coefficient, clear and transparent appearance, light transmission equivalent to the light transmission of the glass plate before treatment.

### Surface Energy Test

Surface energy lower than 12 dynes/cm (6-8 dynes/cm)

### Washability Test

This test is used for determining the abrasion resistance (life) of a coating (precleaned with isopropanol) on a substrate. For said test, glass plates (8 cm×40 cm) were coated, while a Braive Instruments washability apparatus (sold by Braive Instruments) was used with the holder ISO. The holder ISO was applied on the substrate with a load of 454 g. The agents used in the test were demineralised water and Vileda abrasive medium (sold by Vileda).

In this test, a contact angle is measured. The values of the contact angle are put in a diagram (contact angle in function of the number of cycles of washability). When the limit of 85° is reached, the number of cycles is determined.

The glass plates are cleaned with isopropanol and blow dry. The contact angle of the cleaned glass is determined before starting the test. The measurement of the contact angle after a number of washability cycles is always done with the profile of the drop seen from 90° on the direction of the washability movement.

After measuring the initial contact angle, the sample (with the coated face up) is placed on the apparatus, with the sample or plate positioned in the middle of a working station of the apparatus. After fixing the plate, the holder with vileda medium contacts the coated face with a load of 454 g. At each washability cycle, 1 droplet of demineralized water is supplied to the portion of the face in contact with the vileda medium.

After a number of cycles, the contact angle is measured in a portion of the face contacted with the vileda medium. If the contact angle is higher than 85°, the glass plate is further submitted to a number of cycles. This procedure is repeated up to reaching an angle close to 85°.

A hydrophobic glass coating fails when the contact angle drops under 85°. The best abrasion resistance is when a glass coating has the highest number of cycles of washability till reaching a contact angle of 85°.

After 500,000 washability cycles, the contact angle was still higher than 85°. The abrasion resistance (washability test) of the coating was highly increased with respect to commercial products enabling only an abrasion resistance of less than about 50,000 cycles.

When using compositions of WO 00/63129 (for coating a glass substrate equivalent to that used for the test with the composition of the invention) having a higher fluoro silane concentration with respect to the composition of the invention, after less than 200,000 cycles, the contact angle was less than 85°.

### Adhesion Test

The results of this test is that there is a good adhesion of the layer or coating, even after immersion of the glass plate in boiling water for 1 hour. When using the method disclosed in DIN 53151, the edges of the cuts were completely smooth and none of the square of the lattices of the cuts is detached, showing therefore an excellent adhesion.

### Mechanical Test

When using said glass as a car window, it appears that there were less impacts of insects and other dirt, that there was a kind of jumping effect for the particles or insects on the windows, that the cleaning of the window was easier and that a perfect cleaning could be reached with a wiper blade provided with a fluoro or fluorinated layer or coating.

It appears also that in the same cold weather environment (temperature of −5° C.), no freeze was formed on the glass sheet of the invention, while a freeze layer was formed on the non treated glass sheet. The glass sheet of the invention has thus anti freeze properties.

### Example 2

Example 1 was repeated, except that, instead of dipping, the composition was sprayed on a face of the glass sheet.

### Example 3

Example 1 was repeated, except that, instead of dipping, the composition was brushed on a face of the glass sheet.

### Example 4

Example 1 was repeated except that no heat treatment was carried out at 130° C. The drying was carried out at room temperature and was considered as finished after 24 hours. The layer had the same properties than the layer of example 1, except that the delta haze was comprised between 0.2 and 0.3.

### Example 5

Example 1 was repeated, except that 3-ethoxy-1,1,1,2,3,4,4,5,5,6,6,6-dodecafluoro-2-trifluoromethyl-hexane was used as fluoro solvent.

### Example 6

Example 1 was repeated except that the following silane ether was used

CF₃—(CF₂)₅—(CH₂)₂Si(OCH₃)₃

### Example 7

Example 5 was repeated except that the following silane ether was used

CF₃—(CF₂)₅—(CH₂)₂Si(OCH₃)₃

### Example 8

Examples 1 and 5 have been repeated, but with a silane ether of the following formula

CF₃—(CF₂)₇—(CH₂)₂Si(OCH₃)₃

### Example 9

Examples 1 and 5 were repeated, except that a solution of silane ether of the following formula

CF₃—(CF₂)₇Si(OCH₃)₃

was used.

### Example 10

Examples 1 and 5 were repeated, except that the silane ether was replaced by a mix (50% by weight/50% by weight) of silane ethers of the following formula

CF₃—(CF₂)₅—(CH₂)₂Si(OCH₃)₃

and

CF₃—(CF₂)₇—(CH₂)₂Si(OCH₃)₃

### Example 11

Examples 1 and 5 were repeated, except that the fluoro silane ether is a perfluoro polyetherdisilane PFPES-1 prepared by reacting perfluoropolyetherdiester CH₃OC(O)CF₂(CF₂O)₉₋₁₁(CF₂CF₂O)₉₋₁₁CF₂C(O)OCH₃ (with an average molecular weight of about 2000) with 3-aminopropyltrimethoxysilane. (see page 12 of WO 02/30848 and U.S. Pat. No. 3,810,874 for the preparation of said compound, the content of said documents being incorporated by reference).

### Example 12

Example 10 was repeated, except that the compound PFPES-2 as disclosed in WO 02/30848 was used instead of PFPES-1.

### Example 13

Example 10 was repeated, except that the compound PFPES-3 as disclosed in WO 02/30848 was used instead of PFPES-1.

### Example 14

Example 10 was repeated, except that the compound PFPES-4 as disclosed in WO 02/30848 was used instead of PFPES-1.

### Example 15

Example 10 was repeated, except that the compound PFPES-5 as disclosed in WO 02/30848 was used instead of PFPES-1.

### Example 16

Example 10 was repeated, except that the compound PFPES-6 as disclosed in WO 02/30848 was used instead of PFPES-1.

### Example 17

Examples 1 and 5 have been repeated, except that methyl perfluoropropyl ether was used as fluoro solvent.

### Example 18

Examples 1 and 5 have been repeated, except that a mix of ethyl nonafluorobutyl ether (20% by weight) and ethyl nonafluoroisobutyl ether (80% by weight) was used as fluoro solvent.

### Example 19

Examples 1 and 5 have been repeated, except that a mix of methyl nonafluoroisobutyl ether (20% by weight) and methyl nonafluorobutyl ether (80% by weight) was used as fluoro solvent.

### Example 20

The compositions of examples 1, 5, 17, 18, 19 have been placed in a pulverization device comprising a pump, so as to spray the different compositions on different glass sheets.

### Example 21

The compositions of examples 1, 5, 17, 18, 19 have been placed in a pulverization container comprising a device for pressurizing said container to a pressure comprised between 5 and 10 10⁵ Pa. The compositions were then sprayed under pressure by using adapted nozzles.

It was possible to coat a glass sheet homogeneously with a pulverisation rate of about 50 ml/m² or even less.

### Examples 22

The compositions of examples 1, 5, 17, 18, 19 have been placed in a container associated to a gas reservoir provided with a gas spray nozzle and with a venturi. A pipe extend between the venturi of the gas spray nozzle and the container, so as to pump composition and to spray or nebulise composition with said gas.

The gas is propane or butane or dimethylether or a mix thereof.

It was observed that with such an application excellent coating could be achieved, while using extremely low coating rate (less than 100 ml of the composition per m², especially less than 50 ml/m²)

### Examples 23 to 44

Examples 1 to 22 have been repeated with composition not containing TMAH.

### Example 45

The composition used in example 1 was prepared by using a kit consisting of:

A first container comprising 90% by weight perfluorohexane and 10% by weight fluoro silane of the following formula CF₃—(CF₂)₇—(CH₂)₂Si(OCH₃)₃.

A second container comprising ethanol, chlorhydric acid and tetramethylammonium. Said second container is substantially free of water and had a pH of less than 1.

The first composition was mixed with a large volume of the second composition so as to form a composition consisting of:

fluoro silane 0.005% by weight

perfluorohexane 0.02% by weight

TMAH 0.0005% by weight

chlorhydric acid 0.015% by weight

ethanol more than 99.5%

water less than 0.5% (water due to the presence of some water the absolute ethanol).

The pH of said mixed composition was about 1.

### Example 46

Example 1 has been repeated, except that no perfluorohexane was used.

### Example 47

The composition used in example 46 was prepared by using a kit consisting of:

A first container comprising 97% by weight ethanol and 3% by weight fluoro silane of the following formula CF₃—(CF₂)₇—(CH₂)₂Si(OCH₃)₃.

A second container comprising ethanol, chlorhydric acid and tetramethylammonium. Said second container is substantially free of water and had a pH of less than 1.

The first composition was mixed with a large volume of the second composition so as to form a composition consisting of:

fluoro silane 0.005% by weight

perfluorohexane 0.02% by weight

TMAH 0.0005% by weight

chlorhydric acid 0.015% by weight

ethanol more than 99.5%

water less than 0.5% (water due to the presence of some water the absolute ethanol).

The pH of said mixed composition was about 1.

Tests have shown that when using composition of the invention containing extremely low fluoro silane content, the coating had an excellent washability properties and abrasion resistance. Tests have shown abrasion resistance of more than 800,000 washability cycles.

If required or necessary, a previously treated glass or siliceous substrate according to the process of the invention can be coated again in accordance to the process of the invention. Such a further coating can be advantageous in case the fluoro silane layer and/or the face of the substrate provided with the fluoro silane layer have been partially or completely damaged, so as to restore the properties of the siliceous substrate of the invention.

Examples of other possible fluorinated silane suitable to be used in the process of the invention are fluorinated silanes of the group fluoroaliphatic polymeric esters, fluorinated alkyl polyoxyethylene ethanols, fluorinated silane of the general formula: F(CF₂)_{g}(CH₂)ₖSi(CH₃)ₕZ₃₋ₕ,

wherein Z is chloro, hydroxy, methoxy or ethoxy, g is an integer selected from the integers 1 to 10, k is the integer 0, 1 or 2, and h is the integer 0, 1 or 2.

Examples of such fluorinated silanes include trifluoroacetoxypropyl tri-(C1-2)alkoxysilanes, 3-(heptafluoroisopropoxy)propyltrichlorosilane, 3-(heptafluoroisopropoxy) propyltriethoxysilane, N-(3-triethoxysilylpropyl) perfluorooctanoamide, N-(3-triethoxysilylpropyl) perfluoro(2,5-dimethyl-3,6-dioxanonanoyl)amide, (tridecafluoro-1,1,2,2-tetrahydrooctyl)-1-dimethylchlorosilane, (tridecafluoro-1,1,2,2-tetrahydrooctyl)-1-methyldichlorosilane, (tridecafluoro-1,1,2,2-tetrahydrooctyl)-1-trichlorosilane, tridecafluoro-1,1,2,2-tetrahydrooctyl-1-triethoxysilane, 3,3,3-trifluoropropyldimethylchlorosilane, (3,3,3-trifluoropropyl)methydichlorosilane, (3,3,3-trifluoropropyl)methyldimethoxysilane, (3,3,3-trifluoropropyl)methyldimethoxysilane, (3,3,3-trifluoropropyl)trichlorosilane, (3,3,3-trifluoropropyl)trimethoxysilane, 1H, 1H,2H,2H-perfluoroalkyltriethoxysilane, 1H, 1H,2H,2H-perfluorodecyldimethylchlorosilane, 1H, 1H,2H,2H-perfluorodecylmethyldichlorosilane, 1H,1H,2H,2H-perfluorotrichlorosilane, 1H, 1H,2H,2H-perfluorotriethoxysilane, 1H, 1H,2H,2H-perfluorooctylmethyldichlorosilane, 1H, 1H,2H,2H-perfluorooctyltrichlorosilane, and 1H, 1H,2H,2H-perfluorooctyltriethoxysilane.

However, preferably, the silanes used in the process of the invention are silanes of the above mentioned formula but with k equal to 2 and h equal to 0, and with g an integer from 4 to 9, and mixtures of such silanes.

Examples of possible fluorinated polyether silane are given in WO 02/30848, especially as disclosed from page 4,line 4 of WO 02 30848 up to page 6, line 15 of WO 02 30848.

In the example, the coating was carried out by dipping, brushing and spraying. It is clear that any other conventional coating methods, such as spin coating, roll coating, curtain coating, etc., are suitable for applying the silane layer on the substrate.

It is clear that prior to applying the silane layer onto the substrate, the substrate is advantageously treated with a solution for removing possible coating (silane, silicone oil, glue, etc.) present on the surface. Preferably the substrate is treated with a solution which does not degrade the glass substrate. For example, the glass substrate is first treated by means of a solution containing HCl, citric acid, phosphoric acid, etc. or a solution “SILSTRIP LIQUID”® of PENN-WHITE (UK) so as to remove impurities attached to the substrate.

The substrate can be submitted to a mechanical treatment, such as a polishing treatment with powders comprising cerium oxide, prior to its coating.

The substrate, prior to its coating, can also be etched.

The curing is preferably carried out by subjecting the silane layer to a heat treatment, for example between 75 and 150° C., preferably between 95 and 140° C. However, other curing methods are possible, such as infrared, ultraviolet, gamma or electron radiation.

In the present specification, reference is made to the measurement of a pH by means of a LiCl electrode provided with an open sleeve (flushtrode of Hamilton, USA). The potential measured by using this electrode is the potential measured against a reference electrode, namely an Ag/AgCl reference electrode, with use of 1 molar LiCl in ethanol as electrolyte. This electrode is known as suitable for measuring a pH in a partially aqueous media, as well as in a polar non-aqueous media. It is obvious that other electrode suitable for determining a pH in a non-aqueous or substantially non-aqueous media can also be used for determining the pH.

What I claim is:

1. A siliceous substrate having at least a portion of a face which is provided with a water-repellent layer having a thickness of no greater than 1000 Angstroms, said layer being a layer of at least one fluoro silane compound having at least one silicon atom chemically bound to the siliceous substrate and chemically bound to the silicon atom of another fluoro silane compound of the layer, the said layer having such chemical bounds with the siliceous substrate and such chemical bounds between silicon atoms of the layer that it has a chemical resistance of at least 1 minute against the action of an aqueous solution containing 25% by weight of sodium hydroxide and having a temperature of 25° C., said layer being further characterized in that the layer is a fluoro silane layer substantially equally distributed on said portion at a fluoro silane coating rate comprised between 2 mg/m² and 30 mg/m², and in that, after 200,000 washability cycles of a holder with vileda abrasive medium moving in one direction on said fluorosilane layer, said holder being applied on said fluorosilane layer with a load of 454 g, said fluorosilane layer has still a water repellency such that a droplet of demineralized water placed on the layer has a profile seen from 90° with respect to the movement direction of the holder with a contact angle greater than 85°.

2. The siliceous substrate of claim 1, in which the layer is a fluoro silane layer substantially equally distributed, whereby the fluoro silane layer has a coating rate per cm² varying between a minimum coating rate and a maximum coating rate, whereby an average in number coating rate per cm² can be determined, said fluoro silane layer being further characterized in that the maximum coating rate per cm² of the coated portion is at most 25% higher than the average in number coating rate per cm².

3. The siliceous substrate of claim 1, which, after 400,000 washability cycles of a holder with vileda abrasive medium moving in one direction on said fluorosilane layer, said holder being applied on said fluoro silane layer with a load of 454 g, said fluoro silane layer has still a water repellency such that a droplet of demineralized water placed on the layer has a profile seen from 90° with respect to the movement direction of the holder with a contact angle greater than 85°.

4. The siliceous substrate of claim 1, in which the fluorosilane layer is resistant for at least 24 hours at 25° C. when contacted with a composition selected from the group consisting of sulfuric acid with a concentration of more than 99%, phosphoric acid with a concentration of more than 99%, hydrochloric acid with a concentration of 27%, methanol, nitric acid (66%), formic acid with a concentration of 25%, and mixtures thereof.

5. The siliceous substrate of claim 1, in which the fluorosilane layer is characterized by a delta haze of less than 0.3% measured by the method ASTM D 1044-94, using a Taber abraser under the conditions where the abrading wheel was a CS-10F wheel, the load was 500 g and the number of rotations was 3,000.

6. A composition for treating a silicon or siliceous containing substrate, at least 99.5% by weight of said composition consisting of:
from 0.0005% by weight to 0.01% by weight of fluoro silane selected from the group consisting of substantially water insoluble fluoro silanes and mixtures thereof;
at least 0.01% by weight of a fluoro solvent system, said amount of fluoro solvent system being at least sufficient for solubilizing completely said fluoro silane selected from the group consisting of substantially water insoluble fluoro silanes and mixtures thereof,
at least 50% by weight of an alcohol system selected from the group consisting of C1 to C4 alcohols, C1 to C4 dialcohols and mixtures thereof,
less than 0.1% by weight acid system whereby the acid system is adapted for ensuring a pH of less than 2 for the ready-to-use composition, and whereby the water content of said composition is less than 0.5% by weight.

7. The composition of claim 6, which comprises from 0.02% by weight to 1% by weight fluoro solvent.

8. The composition of claim 6, which comprises from 0.01% by weight to 0.03% by weight acid system.

9. The composition of claim 6, in which the acid system is selected from the group consisting of formic acid, citric acid, acetic acid, tartaric acid, hydrochloric acid, phosphoric acid, sulfuric acid, nitric acid and mixtures thereof.

10. The composition of claim 6, which further comprises at least one ammonium and/or phosphonium compound selected from the group consisting of compounds with at least one ammonium group, compounds with at least one phosphonium group, compounds with at least one ammonium group and with at least one phosphonium group, and mixtures thereof, the weight ratio ammonium and/or phosphonium compound/fluoro silane selected from the group consisting of substantially water insoluble fluoro silanes and mixtures thereof being comprised between 0.005 and 1.

11. The composition of claim 6, which is substantially water free.

12. The composition of claim 6, which comprises more than 99% by weight of the alcohol system selected from the group consisting of C1 to C4 alcohols, C1 to c4 dialcohols and mixtures thereof.

13. the composition of claim 6, in which less than 0.5% by weight of the composition consists of:
fluoro silane selected from the group consisting of substantially water insoluble fluoro silanes and mixtures thereof;
fluoro solvent system, said amount of fluoro solvent system being at least sufficient for solubilizing all said fluoro silane selected from the group consisting of substantially water insoluble fluoro silanes and mixtures thereof, and
less than 0.1% by weight acid system

14. The composition of claim 6, in which the fluoro silane is selected from the group consisting of fluorinated polyether silanes of the formula:
R_{f}¹-[-Q-SiY₃₋ₓR¹ₓ]_{y}
wherein R_{f}¹ represent a monovalent or divalent polyfluoropolyether group, Q represents an organic divalent linking group, R¹ represents a C1-C4 alkyl group, Y represents a hydrolysable group, x is 0 or 1 and y is 1 or 2;
and mixtures thereof,
whereby the fluoro silane comprises at least one atom selected from the group consisting of N, P and Cl.

15. The composition of claim 6, which is free of water soluble fluoro silane.

16. A process for coating a face of a silicon or siliceous containing substrate with a silicon containing layer, in which the face is treated with a composition for treating a siliceous containing substrate, in which at least 99.5% by weight of said composition consisting of:
from 0.0005% by weight to 0.01% by weight of fluoro silane selected from the group consisting of substantially water insoluble fluoro silanes and mixtures thereof;
at least 0.01% by weight of fluoro solvent system, said amount of fluoro solvent system being at least sufficient for solubulizing completely said fluoro silane selected from the group consisting of substantially water insoluble fluoro silanes and mixtures thereof,
at least 50% by weight of an alcohol system selected from the group consisting of C1 to C4 alcohols, C1 to C4 dialcohols and mixtures thereof,
less than 0.1% by weight acid system
whereby the acid system is adapted for ensuring a pH of less than 2 for the ready-to-use composition, and whereby the water content of said composition is less than 0.5% by weight.

17. The process of claim 16, in which said composition for treating a siliceous containing substrate comprises from 0.02% by weight to 1% by weight fluoro solvent system.

18. The process of claim 16, in which said composition for treating a siliceous containing substrate comprises from 0.01% by weight to 0.03% by weight acid system.

19. The process of claim 16, in which from 0.1% by weight to 0.3% by weight of said composition for treating a siliceous containing substrate consists of:
fluoro silane sected from the group consisting of substantially water insoluble fluoro silanes and mixtures thereof;
fluoro solvent system, said amount of fluoro solvent system being at least sufficient for solubilizing all said flouorosilane selected from the group consisting of substantially water insoluble fluoro silanes and mixtures thereof, and
less than 0.1% by weight acid system

20. The process of claim 16, in which the fluoro silane of said composition for treating a siliceous containing substrate is selected from the group consisting of fluorinated polyether silanes of the formula:
R_{f}¹-[-Q-SiY₃₋ₓR¹ₓ]_{y}
wherein R_{f}¹ represent a monovalent or divalent polyfluoropolyether group, Q represents an organic divalent linking group, R¹ represents a C1-C4 alkyl group, Y represents a hydrolysable group, x is 0 or 1 and y is 1 or 2;
and mixtures thereof.

21. The process of claim 16, in which said composition for treating a siliceous containing substrate is free of water soluble fluoro silane.

22. The process of claim 16, in which the siliceous or silicon containing substrate is contacted with the composition at a rate of less than 200 ml per m².

23. The process of claim 16, in which the composition is applied on the siliceous or silicon containing substrate by a treatment selected from the group consisting of spraying, pulverization, nebulization, atomization and combination thereof, said treatment being carried out with a propulsing gas selected from the group consisting of propane, isobutane, butane, dimethylether and mixtures thereof.

24. A kit for the preparation of a composition for treating a silicon or siliceous containing substrate, at least 99.5% by weight of said composition consisting of:
from 0.0005% by weight to 0.01% by weight of fluoro silane selected from the group consisting of substantially water insoluble fluoro silanes and mixtures thereof;
at least 0.01% by weight of fluoro solvent system, said amount of fluoro solvent system being at least sufficient for solubilizing completely said flouorosilane selected from the group consisting of substantially water insoluble fluoro silanes and mixtures thereof,
at least 50% by weight of alcohol system selected from the group consisting of C1 to C4 alcohols, C1 to C4 dialcohols and mixtures thereof,
less than 0.1% by weight acid system
whereby the acid system is adapted for ensuring a pH of less than 2 for the ready-to-use composition, and whereby the water content of said composition is less than 0.5% by weight,
whereby said kit comprises at least:
(a) a first container comprising a first composition, whereby at least 99.5% by weight of said first composition consists of:
fluoro silane selected from the group consisting of substantially water insoluble fluoro silanes and mixtures thereof;
fluoro solvent system in an amount at least sufficient for solubilizing at room temperature all said fluoro silane selected from the group consisting of substantially water insoluble fluoro silanes and mixtures thereof,
alcohol system selected from the group consisting of C1 to C4 alcohols, C1 to C4 dialcohols and mixtures thereof,
said composition comprising less than 40% by weight fluoro silane, more than 59.5% by weight alcohol system, and less than 0.5% by weight water, said first composition being free of acid system, and
(b) a second container comprising a second composition, at least 99.5% by weight of said second composition consisting of:
at least 95% by weight of alcohol system selected from the group consisting of C1 to C4 alcohols, C1 to C4 dialcohols and mixtures thereof,
less than 4.5% by weight acid system
said second composition being free of fluoro silane and comprising less than 0.5% by weight water.
